(19) United States
(12) Patent Application Publication
(10) Pub. No.: US 2003/0077135 A1
(43) Pub. Date: Apr. 24, 2003

(54) Cutting tool

(76) Inventor: Jorg Agarico, Bodman-Ludwigshafen (DE)

Correspondence Address: M. Robert Kestenbaum, 11011 Bermuda Dunes NE, Albuquerque, NM, 87111, US

(21) Appl. No.: 10/235,525

(22) Filed: Sep. 5, 2002

(30) Foreign Application Priority Data
Sep. 10, 2001 (DE) 101 44 514.8-14

(51) Int. Cl. B23B 51/00

(52) U.S. Cl. 408/232; 407/41

(57) ABSTRACT

The a cutting tool, especially a reaming and countersinking tool, has having a base body, on which at least one blade is replaceably fixed by clamping by means of at least one tensioning member, the at least one tensioning member comprising a tensioning surface engaging on the blade and a bearing surface facing the base body, wherein the clamping surface of the blade or the tensioning surface of the at least one tensioning member and a region of the bearing surface or of a contact surface in the base body lying opposite the tensioning surface or the clamping surface are disposed at an angle of less than 60° relative to one another.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates to a cutting tool, especially a reaming and countersinking tool, comprising at least one blade, at least one tensioning member, a base body, on which the at least one blade is replaceably fixed by clamping by means of the at least one tensioning member, the at least one tensioning member comprising a tensioning surface engaging on the blade and a bearing surface facing the body.

Cutting tools, especially reaming tools, are used for the precision machining of bores. The quality of the bore is determined by the precise guidance of the guide strips and a blade that is adjustable in diameter.

For precision machining, cutting tools are used in which a blade is provided on a base body to be replaceable by means of a tensioning member. Such a reamer is known, for example, from DE 39 03 655. The tensioning member is of essentially triangular form, an edge length of the triangle engaging on the blade for clamping purposes. The other walls of the clamping claw serve as a contact surface in a milled recess in order to align the tensioning member in a clamping position. The tensioning screw engages on the tensioning member at a distance from the edge engaging on the blade. The lever arm acting between the edge engaging on the blade and the tensioning screw generates a bending stress in the tensioning member. The effective tensioning force is reduced thereby. In addition, as a result of the configuration of the tensioning member, a relatively large swarf space is necessary, as a result of which the base body, viewed in cross section, is attenuated. This may also lastingly influence the dimensional accuracy of the finished bore, as it results in an imbalance in the tool.

DE 197 08 601 has further disclosed a cutting tool which receives a blade replaceably by clamping by means of a tensioning member. The tensioning member engages on an adapter, which receives the blade, or directly on the blade. The tensioning member for clamping the adapter or blade has, viewed in cross section, a nose tapering at a very acute angle, on which a tensioning surface is provided. The tensioning screw is, by analogy with DE 39 03 665, set at a substantial distance from the clamping nose, as a result of which a bending stress is generated when a tensioning force is introduced via the tensioning screw in the tensioning member. The tensioning member is supported on the bottom of the seating for the tensioning member. When the tensioning screw is tightened, the bottom of the seating for the tensioning member forms a stop. As a result, the same disadvantages arise as in DE 39 03 655. In addition, the space needed for the tensioning claw and the adapter for receiving the blade for their disposition in the base body is substantial, as a result of which the dimensional accuracy of the base body, especially in cutting tools of small diameter, is reduced. This in turn can have adverse effects on dimensional accuracy in the precision machining of bores.

### SUMMARY OF THE INVENTION

It is therefore an object of the present invention to provide a cutting tool, especially a reaming or countersinking tool, which generates an increased tensioning force with low flexural stressing of the clamping element and permits simple and precise adjustment and clamping of the blade element with high clamping force.

This object is achieved, according to the invention having at least one blade, at least one tensioning member, a base body, on which the at least one blade is replaceably fixed by clamping by means of the at least one tensioning member, the at least one tensioning member comprising a tensioning surface engaging on the blade and a bearing surface facing the base body.

As a result of the configuration of a cutting tool with at least one tensioning member, which comprises a tensioning surface engaging on a blade and a bearing surface which is provided on a region lying opposite a clamping surface of the blade and is disposed at an angle of less than 60° relative to the clamping surface it is possible for higher tensioning force than in conventional clamping systems to be introduced for clamping of the blade.

The at least one tensioning member is essentially configured in the form of a wedge or flattened wedge and is driven in between a contact surface of the base body and a clamping surface of the blade. As a result of the narrow angle of opening between the blade and the contact surface only very slight leverage forces arise, which generate virtually no bending stresses in the tensioning member, and it is essentially compressive forces that act upon the tensioning member. As a result, the increased clamping force can be achieved. This has the additional consequence that a fixed and secure clamping of the blade in the base body is attained. As a result, vibration-damped machining is made possible during the precision machining of bores. This in turn leads to high quality in the fine machining of bores.

This embodiment according to the invention of a cutting tool can be used for multibladed tools with and without guide strips and for single-blade tools with and without guide strips.

The angular disposition of the tensioning surface relative to the bearing surface of the at least one tensioning member is preferably in a range between 1° and 60°. The enclosed angle here may also include the range of self-obstruction. The smaller the enclosed angle becomes, the greater the clamping forces acting on the blade as a result of the at least one tensioning member. As a result, a virtually one-piece configuration of the blade relative to the base body is achieved, the need for interchangeability still existing because of the wear on the blade.

According to an embodiment of the invention, a bore is provided in the base body to receive the tensioning member and adjoins a receiving bottom of the blade seating or at least partially intersects the latter. This is made possible by the fact that the tensioning force generated by the tensioning screw, which is transmitted via the tensioning member to the blade, is applied as close as possible to the point of engagement of the tensioning surface on the clamping surface of the blade, in order to shorten the lever arms. At the same time, a compact arrangement can thereby be achieved, which is advantageous especially in tools of small diameter, as a sufficiently large cross section of the base body is retained.

Preferably, the receiving bottom of the blade has a web of less than 2 mm in the region of the tensioning member. This makes it possible to achieve an additional reduction of the swarf space and to improve the absorption of forces in the base body.

Preferably, the tensioning member is configured as a cylindrical body, which comprises an oblique surface lying in one plane as a tensioning surface. As a result of this configuration, a simple geometry of the tensioning member is achieved, which is cost-effective in production. At the same time, the high clamping forces can be transmitted.

The tensioning surface is preferably configured as a notch at an acute angle as a continuous oblique surface over the entire thickness of the tensioning member. As a result, a tensioning member can be provided that is stable and pressure resistant in cross section. In addition, as a result of the bore adapted to the tensioning member for receiving the tensioning member, the tensioning member is enabled to fill this space virtually completely, and with the tensioning member in position a virtually continuous edge chamfer is obtained from the base body via the blade through the tensioning member via the bearing surface and the contact surface of the base body and into the region of the base body in turn adjoining the latter.

According to a further embodiment of the invention, provision is made for the tensioning surface of the tensioning member to engage onto the clamping surface of the blade in a virtually parallel manner or at a very acute angle. As a result, the clamping effect can be increased while simple geometries are maintained. The blade at the same time undergoes, when the tensioning force is introduced, at least a slight radially inward-oriented force effect, in order to ensure secure seating. In addition, as a result of the configuration of the oblique surface as a tensioning surface, a greater engagement surface on the clamping surface of the blade can be attained. As a result, it is possible for the force normal of the tensioning surface and the force normal of the bearing surface to be disposed at an angle of from, for example, 150° to nearly 180°, so that these are oriented, as it were, in opposite directions and thereby transmit almost exclusively compressive forces. This alternative arrangement may also be provided between the bearing surface of the tensioning member and the contact surface of the base body.

In accordance with a further embodiment of the invention, provision is made for the bearing surface of the tensioning member to be guided in a bore in the base body and surrounded in a region of at least 180°. As a result of this configuration, the tensioning member is partially or substantially completely surrounded. As a result, the region for support can be substantially increased. In addition, the receiving region for the tensioning member is completely closed by the tensioning member itself, so that the swarf space is closed in this region and unobstructed removal of the swarf is permitted.

Furthermore, provision is advantageously made for the tensioning member to be disposed with its outer end surface flush with the swarf base or slightly below the swarf base in the swarf space. As a result, good swarf removal is retained.

A preferred embodiment provides that the bore axis of the tensioning screw for the tensioning member extends parallel to the bearing surface or contact surface. As a result, simple geometrical conditions are obtained, which again permit cost-effective production.

Alternatively, provision is made for the bore axis of the tensioning screw to extend along the clamping surface of the blade or is provided at any desired angular position between the tensioning surface and the bearing surface or contact surface of the tensioning member. As a function of the size of the base body, the size of the blade and the tensioning forces to be applied, the orientation of the bore axis of the tensioning screw can be adapted.

For example, the tensioning screw can be disposed along the bisector of the angle between the tensioning surface or clamping surface and the bearing surface or contact surface, so that the distance between the bore axis and the tensioning surface and bearing surface and also clamping surface or contact surface is configured equally.

The tensioning member is preferably disposed in a clamping position at a distance from the bore bottom of the seating of the tensioning member. As a result defined force conditions are obtained. The tensioning member is supported exclusively between the clamping surface of the blade and the bearing surface, without any other forces being introduced.

In accordance with a further advantageous embodiment of the invention, provision is made for the width of the tensioning surface engaging on the blade to be configured as less than half the blade length. This size of the tensioning surface is sufficient for a high clamping force for the positioning of the blade in the blade seating. As a result, the volume machined out of the base body can be kept small, as a result of which the rigidity of the base body is in turn increased. This leads to an increase in the machining quality of the bore.

When the tensioning member is tensioned, provision is advantageously made, as a twist-proofing device, for the bore axis of the tensioning screw to be eccentric within the cylindrical tensioning member.

### BRIEF DESCRIPTION OF THE DRAWINGS

Examples of embodiment of the invention are given in the description which follows, the drawings and the patent claims. In the drawings:

FIG. 1 shows a perspective view of a cutting tool;

FIG. 2 shows a diagrammatic cross section of the cutting tool along the line II-II in FIG. 1;

FIG. 3 shows a diagrammatic cross section of a cutting tool along the line III-III in FIG. 1;

FIG. 4 shows an enlarged cross section of a blade clamping system in accordance with FIG. 3; and

FIG. 5 shows an enlarged view in cross section of an alternative blade clamping system to FIG. 4.

### DETAILED DESCRIPTION OF THE INVENTION

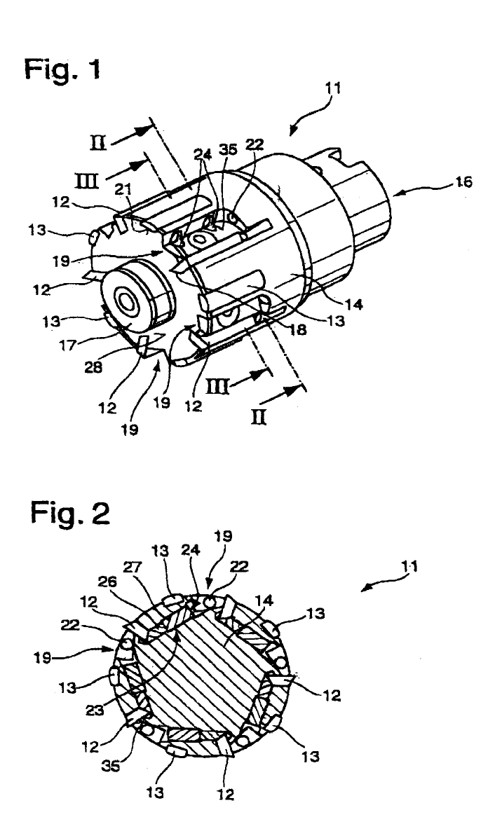

FIG. 1 shows a cutting tool 11 in perspective. For example, a reamer is shown as a multi-bladed reamer which comprises five blades 12, to each of which is assigned a guide strip 13 offset by 180°. This cutting tool 11 may alternatively be configured as a one-, two- or multi-bladed tool with or without guide strips. The cutting tool 11 comprises a base body 14, which makes a transition at one end into a tool seating 16. Optionally provided on an opposite end face is a circular running verification point 17. The blade 12 is replaceably provided in a groove-shaped blade seating 18 in the base body 14. This blade 12 is adjoined, ahead of it in the direction of rotation, by a swarf space 19. In addition, to the rear in the direction of rotation, a guide strip 13 is provided, fixed by soldering or the like, in a seating 21. The guide strips may also be provided in a replaceable manner, preferably in an adapter. The guide strips 13, in a mutlibladed tool in accordance with FIG. 1, are disposed opposite to the blade. In the case of a single-bladed tool, two guide strips are for example provided, one being offset by 180° relative to the blade and the other by, for example, 45°, following behind the blade. Alternatively, not only in a single-blader but also in a two-blader or multiblader, three or more guide strips can be provided, distributed over the circumference, and the number of guide strips may also differ from the number of blades.

A bore 22 opens into the swarf space 19, and feeds in a coolant or lubricant, so that, first, the swarf space 19 is flushed out and, secondly, the blade is supplied with a cooling and/or lubricating emulsion. The swarf space 19 is formed, for example, by a shallow milled incision, whose depth in the example of embodiment is determined by the fact that accessibility to an adjusting member 23 exists. The adjusting member 23 is provided in a bore 24, which extends as far as the next blade seating 18. The adjusting member 23 comprises a cylindrical bolt 26 with a flattened portion which rests below the blade 13 and a threaded pin 27 whereby the bolt 26 can be moved towards the blade 13. The blade 13 in a radial position can be set by the adjusting member 23 to the diameter to be machined.

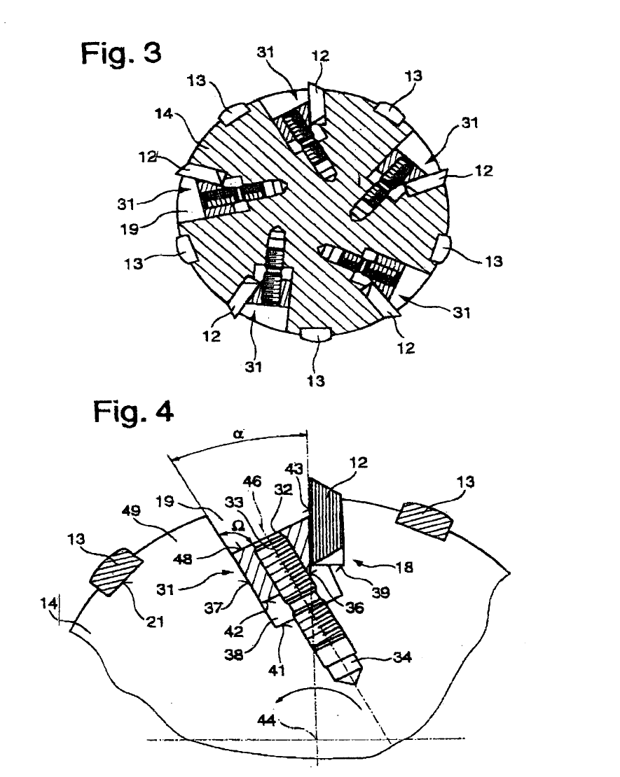

FIG. 3 shows a cross section of the cutting tool 11 along the line III-III in FIG. 1. An enlarged detail of the blade clamping system in FIG. 3 is apparent in FIG. 4. The blade 12 is positioned in the blade seating 18 and is replaceably held in that position by means of clamping by a tensioning member 31. The tensioning member 31 comprises a bore 32 for receiving a tensioning screw 33, which engages into a bore 34 of the base body 14. The bore 34 may alternatively be configured as a through bore. The bore 34 is provided between the two adjusting members 23 for receiving the tensioning member 31. Alternatively, the tensioning member 31 may be provided outside the adjusting members 23, for example close to an engagement zone of the blade 12. The bore 34 for receiving the tensioning member 31 is thus provided directly adjacent to an end face 28. The engagement zone of the blade 12, in the case of reamers, is formed by the short front cutting portion of the main blade, close to the end face 28. The bore is substantially machined to size by the main blade. The long blade portion, which extends parallel to the longitudinal axis 44 of the reamer, is the secondary blade, which causes only slight or virtually no swarf removal. The tensioning screw 33 is configured, for example, with two counter-rotating threads, the effect of which is that when the tensioning screw 33 is rotated the adjustment travel of the tensioning member 31 is doubled. Moreover, the tensioning screw 33 can also be provided as, instead of a differential screw, a screw with a screw head which engages on a stepped bore of the tensioning member 31.

The tensioning member 31 has a tensioning surface 36 engaging on the blade 12. This tensioning surface 36 is configured as an oblique surface which extends over the entire thickness of the tensioning member 31, which is produced from a cylindrical solid material. A bearing surface 37 is provided opposite to the tensioning surface 36. The bearing surface 37 corresponds to the generated surface of the tensioning member 31, which is inserted into and guided in a bore 38. This bore 38 is introduced via the swarf space 19 into the base body 14. The bore 38 intersects a bottom 39 of the blade seating 18, which makes it possible for the bore 38 to be positioned close to the blade 12. Advantageously, the residual web of the bottom 39 is configured to be less than 2 mm. The recess in the bottom 39 is negligible because of the bearing of the blades on oblique surfaces of the bolts 26 of the adjusting member 23.

A bore bottom 41 of the bore 38 is disposed lower than the bottom 39 of the blade seating 18, so that the tensioning member 31, in a clamping position with an inner end surface 42, does not come into contact with the bore bottom 41.

The blade 12 in accordance with FIG. 4 comprises a clamping surface 43, which extends radially to the longitudinal axis 44. The bearing surface 37 for the tensioning member 31 is disposed at an angle α to the tensioning surface 36 of less than 60°. Preferably, an angle of less than 40° or 30° is provided. A tensioning surface 36 is provided opposite to the bearing surface 37 and, in the clamping position, is inclined slightly relative to the clamping surface 43 of the blade 12, so that at least a slight force component is directed radially inwards and acts on the blade 12. The bore axis 46 of the bore 32 is provided, in the example of embodiment in accordance with FIG. 4, substantially parallel to the bearing surface 37 and contact surface 40. At the same time, the bore 32 is provided eccentrically to the diameter of the tensioning member 31, as is apparent from a plan view of the swarf space 19, a twist-proofing system taking effect when the tensioning member 31 is tensioned. The tensioning surface 36 of the tensioning member 31 is produced at an angle by the removal of a segment of a circle. This determines the length of the tensioning surface 36, which adjoins the outer end surface 48 of the tensioning member 31.

The external diameter of the tensioning member 31 corresponds to the bore 38. As a result, the tensioning member 31, with the exception of the region adjoining or opening as a result of the blade seating 18, is completely surrounded by the bore 38. The bearing surface 37 may be in at least linear contact with a contact surface 40, which is part of a bore 38 in accordance with the example of embodiment. If the contact surface 40 is part of a bore 38, the latter may also extend over a relatively large region. As a result of the embodiment of the tensioning member 31 shown, the bore 38 is almost completely filled in again, so that a level bottom 35 of the swarf space is formed. This has the advantage that a slight imbalance is caused in the base body 14. The angle formed between the contact surface 40 and the outer end surface 48 may thus be equal to, greater than or less than 90° and, for example, adapted to the bottom 35 of the swarf space. The geometrical conditions which contribute to an increased tensioning force are retained irrespective of the configuration of the swarf space.

The thickness of the tensioning member 31 is advantageously so configured that the outer end surface 48 extends, in the clamping position, flush with the bottom 35 of the swarf space. The opening angular region for the swarf space 19 can be adapted to the angle enclosed between the clamping surface 43 and the bearing surface 37. As a result, the supporting region 49 can be formed on the base body 14, as a result of which an increase in the percentage content of solid material, viewed in cross section, of the base body 14 is provided. Furthermore, on clamping of the blade 12, widening of the base body 14 by the tensioning member 31 can be prevented.

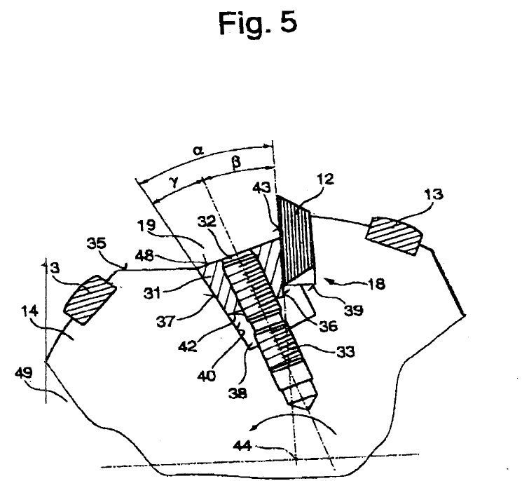

As an alternative to the embodiment shown in FIG. 4, the tensioning member 31 may, in accordance with FIG. 5, comprise a tensioning surface 36 and a bearing surface 37 which is disposed at an acute angle to the clamping surface 43 and the bore shell of the bore 38. The bore axis 46 of the tensioning member 31 may lie in the bisector of the angle between the clamping surface 43 and the bearing surface 37. In this embodiment, the angles γ and β are equal. As a result, the application of a high tensioning force is also possible.

Furthermore, provision may be made for the bearing surface 37 of the tensioning member 31 to extend parallel to the generated surface, in other words to the contact surface 40 of the bore 38, and for the bore axis 46 in the tensioning member 31 not to be parallel to the bearing surface 37. Depending upon the materials and dimensional conditions of the base body 14 and the tensioning member 31, optimum clamping conditions can also be derived herefrom.

Furthermore, provision may advantageously be made for the bearing surface 37 and the tensioning surface 36 to be disposed at a self-obstructing angle. The replaceability of the blade 12 is provided by introducing the tensioning force via the tensioning screw 32. In the range of self-obstruction, the tensioning forces acting on the tensioning surface 36 and the bearing surface 37 may span a wider angle, as a result of which a higher force transmission is obtained.

Provision may also be made for the angles γ and β to be configured to be varied in extent as desired, their sum being equal to or less than the angle α. The bisectors can be positioned parallel or at an angle to the bearing surface 37, tensioning surface 36, clamping surface 43 or contact surface 40.

Furthermore, the tensioning member 31 may comprise a bearing surface 37 extending parallel to the contact surface 40 or at an acute angle thereto. These two alternatives can be selected as desired with an arrangement of the tensioning surface 36 relative to the clamping surface 43 which can encompass both a parallel arrangement and an acute-angled disposition. The angular position of the tensioning member 31 can be freely determined by the angle γ or β.

FIG. 5 shows an alternative arrangement of a swarf space 19 by comparison with FIG. 4. For example, the outer end surface 48 may lie in the prolongation of a bottom 35 of the swarf space, which is shown enlarged in FIG. 5. Depending on the application, the enlarged swarf space 19 may be used. As soon as the bottom 35 of the swarf space is disposed, for example, in an angular position, in order to form an even larger swarf space 19, the outer end surface 48 may again be adapted flush therewith.

The abovementioned embodiments also apply to blades which comprise a slightly inclined clamping surface relative to the blade contact surface in the blade seating 18. The above remarks also apply to indexable inserts and other types of blade that are used for cutting, reaming and countersinking tools.

1. (amended) cutting tool comprising
at least one blade,
at least one tensioning member,
a base body (14), on which said at least one blade (12) is replaceably fixed by clamping by means of said at least one tensioning member (31), the at least one tensioning member (31) comprising a tensioning surface (36) engaging on the blade (12) and a bearing surface (37) facing the base body (14), wherein a clamping surface (43) of the blade (12) or the tensioning surface (36) of the at least one tensioning member (31) and a region of the bearing surface (37) or of a contact surface (40) in the base body (14) lying opposite the tensioning surface (36) or the clamping surface (43) are disposed at an angle of less than 60° relative to one another:

2. (Amended) Cutting tool according to claim 1, comprising
a bore (38) in the base body (14) to receive the tensioning member (31) a blade (39) of the blade section that adjoins or at least partially intersects the base (39) of the blade seating (18).

3. (Amended) Cutting tool according to claim 2, wherein the base (39) of the blade seating (18) comprises a web, of less than 2 mm, in the region for receiving the tensioning member (31).

4. (Amended) Cutting tool according to claim 1, wherein the tensioning member (31) comprises a cylindrical body which comprises an oblique surface lying in one plane as said tensioning surface (36) which extends over an entire height of the tensioning member (31).

5. (Amended) Cutting tool according to claim 1, wherein the tensioning surface (36) of the tensioning member (31) engages onto the clamping surface (43) in a parallel or virtually parallel manner or at a very acute angle.

6. (Amended) Cutting tool according to claim 1, wherein the bearing surface (37) engages onto the contact surface (40) in the base body (14) in a parallel or virtually parallel manner or at a very acute angle.

7. (Amended) Cutting tool according to claim 2, comprising a bore in the base body wherein the bearing surface (37) of the tensioning member (31) is guided in the bore (38) in the base body (14).

8. (Amended) Cutting tool according to claim 7, wherein the tensioning member (31) is surrounded to the extent of at least 180° by the bore (38).

9. (Amended) Cutting tool according to claim 7, wherein the tensioning member (31) with the exception of the tensioning surface (36) is completely surrounded by the bore (38).

10. (Amended) Cutting tool according to claim 1, comprising a swarf space having a bottom wherein the tensioning member (31) is positioned in a clamping position flush with or below the bottom (35) of the swarf space.

11. (Amended) Cutting tool according to claim 1, comprising a tensioning screw (33) having the bore axis (46) provided in the tensioning member (31) parallel to the bearing surface (37) or contact surface (40).

12. (Amended) Cutting tool according to claim 11, wherein the bore axis (46) of the tensioning screw (33) extends to the tensioning member (31) along a bisector between the tensioning surface (36) and the bearing surface (37) or the contact surface (40).

13. (Amended) Cutting tool according to claim 11, wherein the bore axis (46) of the tensioning screw (33) is provided at any angle γ or β between the tensioning surface (36) and the bearing surface (37) or contact surface (40), where the sum of the angles γ and β is equal to or less than an angle α.

14. (Amended) Cutting tool according to claim 2, wherein an inner end face (42) of the tensioning member (31) is disposed in a clamping position at a distance from a bore bottom (41) of the bore (38).

15. (Amended) Cutting tool according to claim 1, wherein a width of the tensioning surface (36) engaging on the blade (12) is configured to be less than half the blade length.

16. (Amended) Cutting tool according to claim 1, wherein the tension screw has a bore axis (46) and bore axis (46) of the tensioning screw (33) is provided eccentrically in a cylindrical tensioning member (31).

17. (Amended) Cutting tool according to claim 1, wherein the at least one tensioning member (31) is provided between adjusting members (23) setting the blade (12) in a radial position.

18. (Amended) Cutting tool according to claim 1, wherein the tensioning member (31) is provided close to an end face (28) of the cutting tool in an engagement region of the blade (12).
